(19) United States
(12) Patent Application Publication
(10) Pub. No.: US 2012/0125454 A1
(43) Pub. Date: May 24, 2012

(54) Flow-through pressure regulator device for irrigation plants

(76) Inventor: Arno Drechsel, Lienz (AT)

(21) Appl. No.: 13/380,884

(22) PCT Filed: Jul. 9, 2010
(86) PCT No.: PCT/IB2010/053151

§ 371 Date: Feb. 8, 2012

(30) Foreign Application Priority Data
Jul. 10, 2009 (IT) VI2009A000170

(51) Int. Cl. G05D 16/06

(52) U.S. Cl. 137/528

(57) ABSTRACT

A pressure regulator for irrigation systems, comprising a main body (2) defining an axis (X), which has an inlet port (3) for irrigation water, and outlet port (4) and a chamber (8) for detection of water pressure changes, which is in fluid connection with the outlet port (4); a closing member (9) sliding along the axis (X) between a rest position distal from the inlet port (3) and a work position proximal thereto; a regulating member (15) fixed in the detection chamber (8) and operably connected with the closing member (8) for detecting its position along the axis (X) in response to the detected pressure. The regulating member (15) comprises an elastomeric wall (16).

### FIELD OF THE INVENTION

The present invention finds application in the field of irrigation devices and particularly relates to a liquid pressure regulator device.

### BACKGROUND ART

Irrigation systems, such as the so-called “center pivot” systems are known to use pressure regulating devices to maintain the outlet pressure of irrigation liquid at a substantially constant level. These systems may consist of sections, possibly as long as hundreds of meters, with liquid outlet pipes branching therefrom.

A sprinkler is also mounted at the end of each pipe for appropriately directing flow, with a pressure regulator being inserted upstream therefrom to ensure constant outlet pressure and, as a result, a regular supply of liquid to the soil.

These regulators, generally known as flow through regulators, have a main body defining an axis, with an inlet port for irrigation water, an outlet port and a chamber for detection of irrigation water pressure changes, which is in fluid connection with the outlet port. In the detection chamber, there is a stagnation pressure given by the downstream nozzle.

These regulators also have a closing member which is able to slide along the axis for selectively changing the liquid port in response to a pressure change detected in the chamber. Therefore, by regulating the position of the closing member relative to the port, the pressure of water from the regulator can be regulated regardless of the flow.

In order to adjust the position of the closing member, prior art regulators generally have a thin diaphragm, usually made of rubberized fabric, or anyway a material having an inelastic behavior, which is fixed in the detection chamber and operably connected to the closing member.

The diaphragm is lifted by the action of water from the outlet port, and causes the closing member to slide along the axis in the inlet port closing direction.

Water pressure on the diaphragm, and hence on the closing member, is typically counteracted by metal compression springs, which are generally preloaded and interact with the movable closing member to reach a dynamic balance position, for pressure regulation.

Solutions of this type are disclosed, for instance, in U.S. Pat. No. 7,048,001 and U.S. Pat. No. 5,881,757.

An apparent drawback of these solutions is that any abrupt liquid pressure variation may easily generate oscillatory motions of the movable closing member. Any abrupt liquid pressure increase, for instance when the system is started, actuates the elastic spring, thereby causing the shaped head of the movable closing member to close the port. As a result, liquid flow stops, the pressure acting on the second face of the resilient diaphragm rapidly decreases and the spring re-opens the port, thereby causing an abrupt pressure increase and the start of an oscillatory motion.

The oscillations of the movable closing member cause the device to operate irregularly and significantly decrease the life thereof. Also, the oscillations propagate as vibrations to the irrigation system, which may be damaged thereby.

Also, prior art devices are composed of various mutually moving parts which cause further friction and wear.

Another apparent drawback of prior art solutions is the provision of a typically preloaded regulating spring, which makes the port opening and closing movements by the piston even more abrupt.

Also, the constant of the spring, which is rather high for this size, affects uniform linearity of the regulated outlet pressure, as compared with the rated value. At low flows, the outlet pressure from these prior art regulators will be higher than the rated nominal pressure, whereas at relatively high flows, it will be slightly lower than such rated value.

A further drawback of prior art regulators is their excessive hysteresis, i.e. the difference between the nominal pressure of the regulator and the actual outlet pressure in case of changes in the inlet pressure. Such excessive hysteresis is caused, amongst other things, by the need for prior art regulators to damp vibrations using O-rings or elastic rings.

### DISCLOSURE OF THE INVENTION

The object of the present invention is to at least partially obviate the above drawbacks, by providing a liquid pressure regulating device, particularly for use in irrigation systems, that is highly efficient and relatively cost-effective.

A particular object is to provide a pressure regulator device that is not exposed to abrupt outlet pressure changes and oscillations of the closing member in the device.

Another object of the present invention is to provide a device that has a simple construction, and thus affords a considerable reduction of the friction generated by mutual movements of its parts, while also reducing the number of such parts and hence manufacturing costs.

A further object of the invention is to provide a regulator device that affords regular liquid flow, thereby damping any abrupt pressure changes in the incoming liquid.

Another object of the invention is to provide a regulator device that affords minimized hysteresis.

These and other objects, as better explained hereafter, are fulfilled by a pressure regulator as defined in claim 1.

The pressure regulator may include a main body, defining an axis, with an inlet port and an outlet port for irrigation water.

A chamber may be further provided in the main body, which is in fluid communication with the outlet port, for detection of pressure changes in outflowing water.

The main body of the regulator, that may comprise a lower half-shell and an upper half-shell in mutual snap-fit relation, may also include a closing member, which is adapted to slide along the axis thereof between a rest position distal from the inlet port and a work position proximal thereto, that may change in response to any change in the pressure detected in the chamber.

In a preferred, non limiting embodiment, the inlet port may be defined by the passageway between the upper end or closing surface of the closing member and the lower surface of a fixed member placed upstream from the inlet port.

The axial position of the closing member, and hence the outlet pressure, may be adjusted by the provision of a regulating member fixedly located in the detection chamber, preferably at the bottom wall thereof, and operably connected with the closing member.

The regulating member may include an elastomeric wall, preferably facing toward the bottom wall of the chamber.

As used herein, the term “elastomeric wall” is intended to designate a wall that is capable of undergoing elastic strains when it is loaded and to substantially return to its original configuration once the load is removed.

With this particular configuration, the device of the invention affords regulation of the incoming liquid pressure, to prevent any abrupt change thereof, thereby avoiding oscillations in the device.

Due to its elastomeric nature, the regulating wall, is susceptible to elastic stretching under the action of water pressure, thereby allowing both axial sliding of the closing member from the rest position to the work position and damping of any pressure changes or water hammers that might occur in the irrigation system, for instance at startup, because elastic stretching increases its lower surface which is acted upon by pressurized water.

Also, such elastomeric nature will cause the wall to elastically pull the closing member back to the rest position.

In other words, the regulating member will act as a traction spring, having a minimum size in the unloaded state and a maximum size in the loaded state. Such “traction spring” is linked on the one hand to the closing member, which will be in turn axially movable under the thrust of water and on the other hand to the pressure detection chamber, particularly to the bottom wall thereof, which will act as a fixed point.

The regulating member may be designed and/or sized for the closing member to be in its rest position when the elastomeric wall is unloaded.

In other words, the elastomeric wall acts both as a means for promoting axial motion of the closing member and as a counteracting elastic means, which tasks were performed in prior art regulators by two different elements, i.e. the cloth diaphragm and the counteracting spring. The elastomeric wall may be thus appropriately sized and/or designed for this purpose.

Advantageously, there will be no other elastic member and particularly no spring, acting on the closing member to elastically pull it toward the rest position, which will afford simple and cost-effective manufacture of the regulator.

In order to minimize the problems associated with water hammering, in a particular embodiment of the invention the elastomeric wall of the regulating member may have a shape substantially mating the shape of the bottom wall of the regulating chamber, to substantially contact it in the rest position.

This will eliminate any air gap between the upper surface of the bottom wall and the lower surface of the elastomeric wall, which would aggravate the problem.

Particularly, the elastomeric wall may be entirely formed of an elastomeric material, such as silicone rubber, which may advantageously have a Shore A hardness from 35 to 60. Also, elongation at break of the material may be indicatively greater than 120%, preferably greater than 200% and more preferably greater than 300%.

The regulating member may be entirely formed of elastomeric material.

Advantageous configurations of the invention will be defined in the dependent claims.

### BRIEF DESCRIPTION OF THE DRAWINGS

Further features and advantages of the invention will be more apparent from the detailed description of a preferred, non-exclusive embodiment of a pressure regulator device of the invention, which is described as a non-limiting example with the help of the annexed drawings, in which:

FIG. 1 is a cross sectional view of a first embodiment of the regulator of the invention, in which the closing member 9 is distal from the inlet port 3 and the regulating member 15 is unloaded, in the rest position;

FIG. 2 is a cross sectional view of the regulator of FIG. 1, in which the closing member 9 is proximal to the inlet port 3 and the regulating member 15 is loaded, in a work position;

FIG. 3 is a broken away isometric view of the regulating member 15 of the regulator of FIG. 1;

FIG. 4 is an exploded view of a few details of the regulator of FIG. 1;

FIG. 5 is an exploded view of the regulator of FIG. 1;

FIG. 6 is a cross sectional view of a second embodiment of the regulator of the invention, in which the closing member 9 is distal from the inlet port 3 and the regulating member 15 is unloaded, in the rest position;

FIG. 7 is a cross sectional view of the regulator of FIG. 6, in which the closing member 9 is proximal to the inlet port 3 and the regulating member 15 is loaded, in a work position;

FIG. 8 is a broken away isometric view of the regulating member 15 of the regulator of FIG. 6;

FIG. 9 is a cross sectional view of a third embodiment of the regulator of the invention, in which the closing member 9 is distal from the inlet port 3 and the regulating member 15 is unloaded, in the rest position;

FIG. 10 is a cross sectional view of the regulator of FIG. 9, in which the closing member 9 is proximal to the inlet port 3 and the regulating member 15 is loaded, in a work position;

FIG. 11 is a broken away isometric view of the regulating member 15 of the regulator of FIG. 9;

FIG. 12 shows charts of the hysteresis tests on a first regulator, mod. PSR 10 PSI by Senninger Irrigation, a second regulator, mod. Universal flow LF 10 PSI by Nelson Irrigation and a third pressure regulator according to the present invention.

### DETAILED DESCRIPTION OF A FEW PREFERRED EMBODIMENTS

Referring to the annexed figures, the pressure regulator of the invention, generally designated by numeral 1, is of the flow through type, and is adapted for use in irrigation systems, e.g. of the “center pivot” type, possibly in combination, as is known, with sprinkler devices or the like.

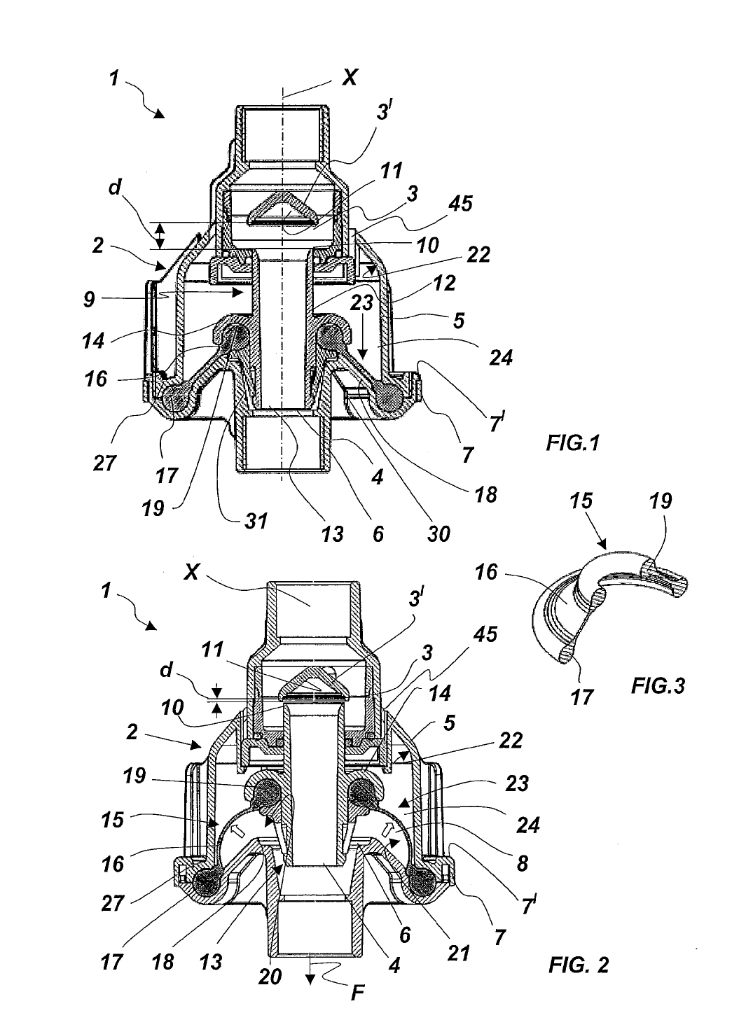

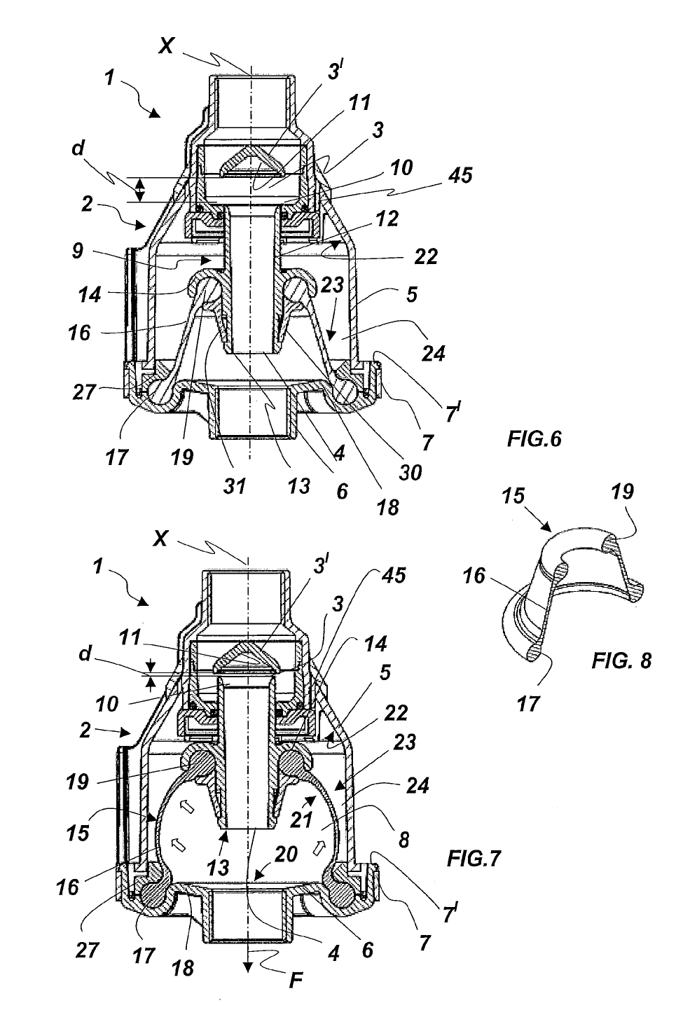

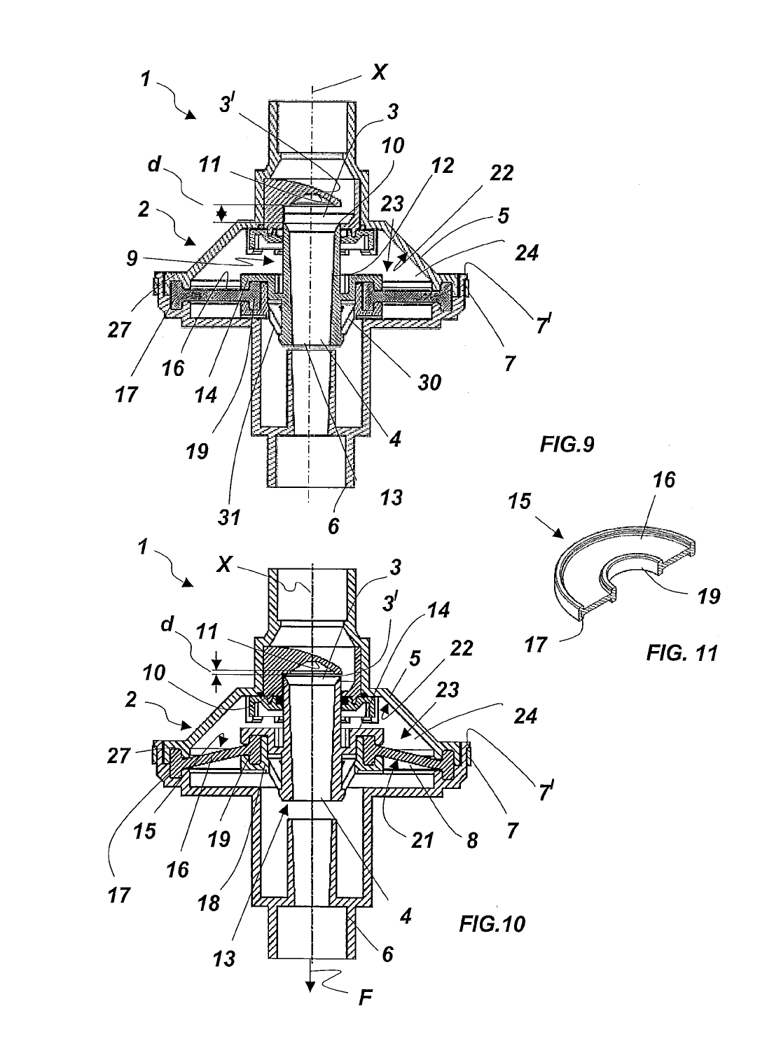

FIGS. 1 to 5 show a first embodiment of the irrigator of the invention, FIGS. 6 to 8 a second irrigator of the invention and FIGS. 9 to 11 a third embodiment of the irrigator of the invention. Unless otherwise stated, the above technical features are intended to be present in all of these three embodiments.

In all the embodiments, the regulator device 1 of the invention may include a main body 2 extending along a longitudinal axis X, which has an inlet port 3 for irrigation water and an outlet port 4 therefor. A fixed member 3′ of generally concave shape, is formed in the proximity of the inlet port 3, and will have the function as described below.

Advantageously, the main body 2 may be composed of two half-shells 5 and 6, which may be coupled together by clips 7, 7′. This arrangement will afford quicker and simpler assembly of the regulator 1.

Furthermore, the main body 2 may include a chamber 8, in fluid connection with the outlet port 4, for detection of pressure changes in irrigation water flowing out from the regulator.

A closing member, generally designated by numeral 9, may be placed in the main body 2, to progressively open or close the inlet port 3 in response to the outlet pressure detected in the chamber 8. Thus, the closing member 9 may move between a rest position, as shown in FIGS. 1, 6 and 9, distal from the inlet port 3 and a work position, as shown in FIGS. 2, 7 and 10, proximal thereto.

For this purpose, the closing member 9 may be mounted in such configuration as to be able to slide along the axis X to cooperate with the fixed element 3′ by moving toward and away from it to change the mutual distance d, that will define the inlet port 3. For this purpose, the closing member 9 may have an upper closing end 10 facing toward the lower surface 11 of the fixed member 3′.

In a preferred non-limiting embodiment, the closing member 9 may have a tubular body 12, having an upper end 10 and a lower end 13 that defines the outlet port 4. In practice, the tubular body 12 ensures fluid communication between the inlet port 3 and the outlet port 4 and irrigation water operably flows through it in the direction of arrow F during operation of the regulator 1.

Also, the closing member 9 may include an annular flange 14, whose purpose will be explained below.

The main body 2 may further include a regulating member, generally designated by numeral 15, which may include or be composed of a central elastomeric wall 16 having a first end 17 fixed in the detection chamber 8, preferably at the bottom wall 18 and a second end 19 operably connected with the closing member 9 to adjust its position along the axis X, thereby adjusting the distance d and hence the outlet pressure.

This configuration will hold the elastomeric wall 16 facing toward the bottom wall 18 of the chamber 8.

Particularly, the upper surface 20 of the bottom wall 18 and the lower surface 21 of the elastomeric wall 16 may define the pressure detection chamber 8.

On the other hand, the inner surface 22 of the upper half-shell 5 and the upper surface 23 of the elastomeric wall 16 may define a second chamber 24, which is in fluid communication with the external environment and thus is held at atmospheric pressure.

Fluid communication of the second chamber 24 with the external environment may be ensured by a plurality of passageways 45 formed, for instance, in the upper portion of the half-shell 5. The regulating member 15, and particularly its elastomeric wall 16, may be particularly useful to prevent ingress of water into the second chamber 24.

In a preferred, non-limiting embodiment, the regulating member 15 may be entirely formed of elastomeric material, such as silicone rubber, and may advantageously have A Shore a hardness from 30 to 65, preferably from 40 to 50. Also, elongation at break of the material may be indicatively greater than 120%, preferably greater than 200% and more preferably greater than 300%.

As particularly shown in FIGS. 1, 6 and 9, the regulating member 15, in its rest position, will be able to withstand the weight of the closing member 9 without being deformed thereby and maintaining its own shape, as shown in FIGS. 3, 8 and 11.

Preferably, the central elastomeric wall 16, the first end 17 and the second end 19 may be monolithically formed, which means that the regulating member 15 may be formed of one piece.

In a preferred, non-limiting embodiment, as shown in FIGS. 1 to 5, the regulator 1 may be designed for the elastomeric wall 16 of the regulating member 15 to substantially contact the bottom wall 18 of the pressure detection chamber 8 facing toward it.

Thus, when the regulating member 15 is in the latter position, there is very little or no air in the chamber 8.

In this case, the bottom wall 18 of the pressure detection chamber 8 and the elastomeric wall 16 of the regulating member 15 may conveniently have a generally frustoconical shape.

Particularly, as shown in FIG. 3, the regulating member 15 may have a generally frustoconical or “bell” shape, with the first end 17 and the second end 19 of generally toroidal shape and the elastomeric wall 16 of frustoconical shape.

On the other hand, as shown in the embodiments of FIGS. 6 to 11, the regulator 1 may be designed for the elastomeric wall 16 of the regulating member 15 to be spaced from the bottom wall 18 of the pressure detection chamber 8 facing toward it, in the rest position.

Particularly, in the second embodiment, as shown in FIGS. 6 to 8, the regulating member 15 may have a generally frustoconical or “bell” shape, with the first end 17 and the second end 19 of generally toroidal shape and the elastomeric wall 16 of frustoconical shape forming an angle greater than that as shown in FIG. 3.

Furthermore, in the third embodiment, as shown in FIGS. 9 to 11, the regulating member 15 may generally have a disk shape, with the first end 17 and the second end 19 of generally toroidal shape and the elastomeric wall 16 generally having the shape of an annulus.

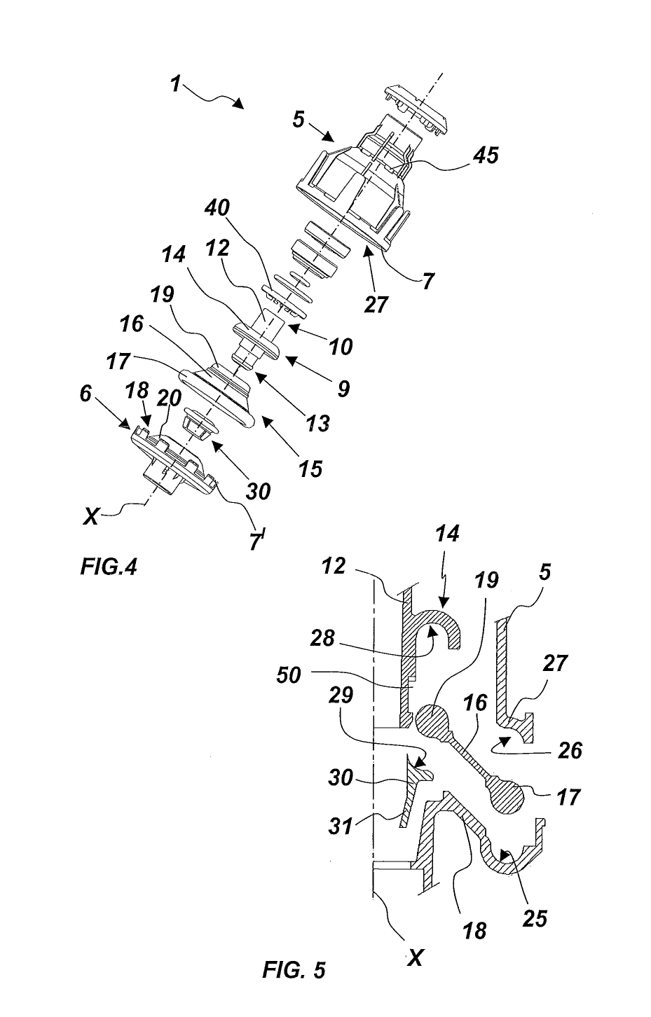

In order to ensure watertight assembly of the various parts, as shown in FIG. 4 for the first embodiment, the bottom wall 18 of the chamber 9, that may be integral with the lower half-shell 6, may have a first peripheral toroidal recess 25 open at its top, for cooperation with a corresponding second toroidal recess 26, open at its bottom, formed at the periphery of a first fastening ring 27, integral with the upper half-shell 5 to define a first watertight seat for the first end 17 of the regulating member 15.

On the other hand, in the embodiments as shown in FIGS. 6 to 11, the first fastening ring 27 is a separate annular member, which is maintained in its operating position by the upper half-shelf 5.

Nevertheless, also in the first embodiment as shown in FIGS. 1 to 5 the first fastening ring 37 may be a separate annular member maintained in the operating position by the upper half-shell, and in the embodiments as shown in FIGS. 6 and 11, the first fastening ring 27 may be also integral with the upper half-shell 5, without departure from the scope as defined in the annexed claims.

The annular flange 14 of the closing member 9 may have a third toroidal recess 28 open at its bottom, which is designed to cooperate with a corresponding fourth toroidal recess 29 open at its top, and formed at the periphery of a second fastening ring 20, having a clip 31 snap-fitted into the groove 50 of the closing member 9 to define a second watertight seat for the second toroidal end 19 of the regulating member 15.

In operation, irrigation water reaches the regulator 1 through the inlet port 3, flows through the tubular member 12 to the outlet port 4, which is in fluid connection with the pressure regulating chamber 8.

Therefore, once water reaches the chamber 8, it will fill it and flow over the lower surface 21 of the elastomeric wall 16. The elastomeric nature of the latter will cause it to elastically stretch, and expand its surface, thereby allowing the closing member 9 linked thereto by the first end 17 to translate upwards along the axis X, thereby moving from the distal rest position to the proximal work position.

On the other hand, this will cause progressive obstruction of the inlet port 3 or, in other words, reduction of the distance d between the obstructing end 10 and the lower surface 11 of the fixed member 3′, until a dynamic balance position is reached for pressure regulation.

The elastomeric nature of the wall 16 will allow it to damp abrupt pressure changes, prevent oscillations of the closing member 9 and absorb any water hammers.

Furthermore, since the elastomeric wall 16 is fixed in the chamber 8, and particularly to its bottom wall 18, it is adapted to elastically pull the closing member 9 from the work position back to the rest position.

In other words, the elastomeric wall 16 may be appropriately sized and/or designed to act both as a means for promoting the axial motion of the closing member 9 and as an elastic counteracting means acting upon it.

The thickness of the wall 16 will change according to the nominal pressure of the regulator, and may particularly range from 0.5 mm to 6 mm for nominal pressures from 0.4 bar to 2 bar.

Advantageously, no additional elastic member, and particularly no spring, will act upon the closing member 9 to elastically pull it from the work position back to the rest position. Particularly, no counteracting spring is provided in the atmospheric pressure chamber 24.

The above disclosure clearly shows that the device of the invention fulfils the intended objects, and particularly affords liquid pressure regulation with incurring abrupt pressure changes, thereby attenuating oscillations in the device, even during transient operation of the system that contains the device.

Also, the pressure regulator of the invention is substantially insensitive to water hammering.

Another important advantage of the regulator of the invention is the quasi total elimination of hysteresis.

Thus was shown by hysteresis tests on a first regulator, mod. PSR 10 PSI sold by Senninger Irrigation, and complying with the teachings of U.S. Pat. No. 5,881,757, a second regulator, mod. Universal flow LF 10 PSI, sold by Nelson Irrigation and complying with the teachings of U.S. Pat. No. 7,048,001 and a third pressure regulator according to the present invention.

The tests were performed using the same apparatus for the three regulators.

Particularly, the regulators were connected to a water supply pipe with water flowing therethrough first at increasing and then at decreasing pressures, and were connected downstream to a sprinkler with a 6 mm outlet nozzle. Two pressure sensors were used for pressure detection, at the inlet and at the outlet of each regulator respectively, with pressure values detected by software means every 100 milliseconds.

Nominal pressure was 0.7 bar, i.e. 10 PSI, for all three regulators.

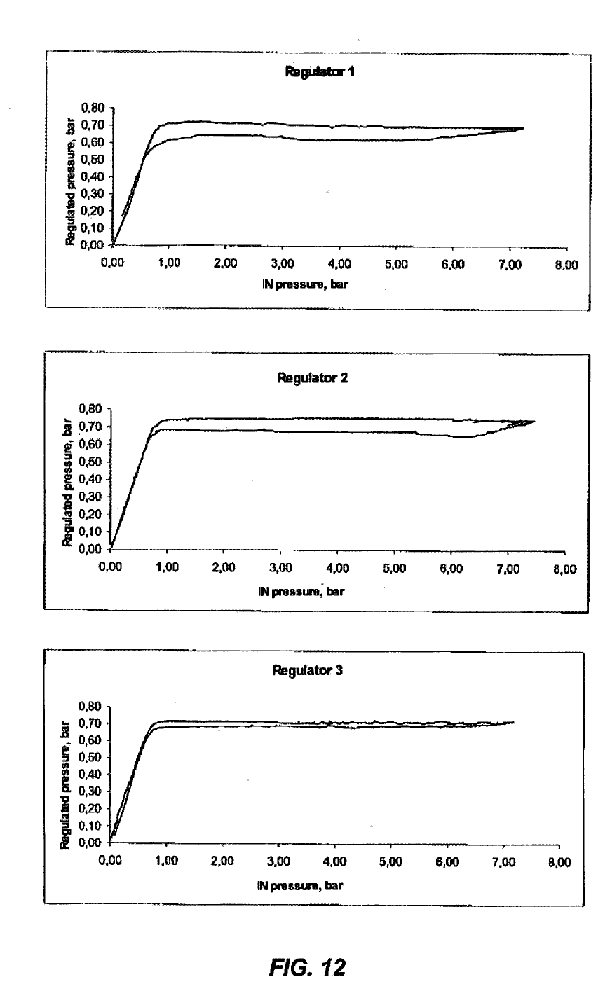

The results of these tests are shown in FIG. 12, in which, for each regulator, the X axis represents the inlet pressure (bar) and the Y axis represents the regulated pressure (bar). In each chart, the upper curve corresponds to the increasing inlet pressure and the lower curve corresponds to the decreasing inlet pressure.

From top to bottom the first chart (“Regulator 1”) relates to the hysteresis test conducted on the regulator mod. Universal flow LF 10 PSI by Nelson Irrigation, the second chart (“Regulator 2”) relates to the hysteresis test conducted on the regulator mod. PSR 10 PSI by Senninger Irrigation and the third chart (“Regulator 3”) relates to the hysteresis test conducted on the regulator of the present invention, still at 10 PSI (0.7 bar) nominal pressure.

These tests clearly show that, under identical conditions, while the regulators mod. Universal flow LF 10 PSI by Nelson Irrigation and mod. PSR 10 PSI by Senninger Irrigation are strongly affected by hysteresis, the regulator of the invention eliminates this problem almost completely, particularly at high pressures.

The device of this invention is susceptible to a number of changes and variants, within the inventive concept disclosed in the appended claims. All the details thereof may be replaced by other technically equivalent parts, and the materials may vary depending on different needs, without departure from the scope of the invention.

While the device has been described with particular reference to the accompanying figures, the numerals referred to in the disclosure and claims are only used for the sake of a better intelligibility of the invention and shall not be intended to limit the claimed scope in any manner.

The invention claimed is:

1. A flow through pressure regulator for irrigation systems, comprising:
a) a main body defining an axis (X), the main body having an inlet port for irrigation water, an outlet port and a chamber for detection of irrigation water pressure changes, which is in fluid connection with the outlet port;
b) a closing member sliding along the axis (X) between a rest position distal from the inlet port and a work position proximal thereto; and
c) a regulating member comprising an elastomeric wall fixed in said chamber and operably connected with said closing member for detecting a position of said closing member along said axis in response to the detected pressure.

2. The regulator as claimed in claim 1, wherein said elastomeric wall is designed or sized to be elastically stretched under action of the water pressure in said chamber, thereby automatically promoting axial sliding of said closing member from said rest position to said work position, said elastomeric wall being further adapted to elastically pull said closing member from said work position back to said rest position.

3. The regulator as claimed in claim 2, wherein no additional elastic member acts upon said closing member to elastically pull said closing member from said work position back to said rest position.

4. The regulator as claimed in claim 1, wherein said chamber has a bottom wall, said regulating member having a first end fixed to said bottom wall and a second end connected to said closing member to maintain said elastomeric wall facing toward said bottom wall.

5. The regulator as claimed in claim 4, wherein said elastomeric wall of said regulating member and said bottom wall of said chamber are designed or sized to come substantially in mutual contact when said closing member is in the rest position.

6. The regulator as claimed in claim 1, wherein said elastomeric wall of said regulating member has a generally frustoconical or a generally discoidal shape.

7. The regulator as claimed in claim 1, wherein said regulating member is entirely formed of elastomeric material.

8. The regulator as claimed in claim 4, wherein said main body comprises a lower half-shell and an upper half-shell coupled together.

9. The regulator as claimed in claim 8, wherein an upper surface of said bottom wall and a lower surface of said elastomeric wall define said chamber, an inner surface of said upper half shell and an upper surface of said elastomeric wall defining a second chamber in fluid communication with an external environment.

10. The regulator as claimed in claim 1, further comprising a fixed member susceptible of cooperating with said closing member to define said inlet port, said closing member comprising a substantially hollow tubular member having an upper obstructing end facing toward a lower surface of said fixed element and a lower end defining said outlet port.

11. The regulator as claimed in claim 8, wherein said lower half-shell and upper half-shell are coupled together in mutual snap-fit relation.
